(19) United States
(12) Patent Application Publication
(10) Pub. No.: US 2013/0082912 A1
(43) Pub. Date: Apr. 4, 2013

(54) Display Drives Circuits and Techniques

(71) Applicant: Euan C. Smith, Cambridgeshire (GB)

(72) Inventor: Euan C. Smith, Cambridgeshire (GB)

(73) Assignee: CAMBRIDGE DISPLAY TECHNOLOGY LIMITED, Cambridgeshire (GB)

(21) Appl. No.: 13/611,616

(22) Filed: Sep. 12, 2012

(30) Foreign Application Priority Data
Sep. 29, 2011 (GB) 1116787.1

(51) Int. Cl. G09G 3/32

(52) U.S. Cl. 345/82

(57) ABSTRACT

A pixel driver architecture for an active matrix OLED display, the pixel driver architecture comprising a voltage-programmed master pixel programming circuit, and a first plurality of current-programmed slave pixel driver circuits, each coupled to said master pixel programming circuit.

### FIELD OF THE INVENTION

This invention relates to improved techniques for driving organic light emitting diodes (OLED) displays.

### BACKGROUND OF THE INVENTION

It is known to drive an OLED display using an active matrix arrangement in which individual pixels of the display are activated by an associated thin film transistor (TFT). The brightness of an OLED pixel of such a display may be programmed by either a voltage or a current. (In this specification references to ‘pixels’ are to be interpreted as including different colored sub-pixels of a color display). In either case a typically memory element is associated with each pixel so that the data written to a pixel is retained while other pixels are addressed. Generally this is achieved by a storage capacitor which stores a voltage set on the gate of a driver transistor, which in turn dictates the current through the OLED pixel. However the voltage on the gate of the TFT driver transistor, and hence the OLED current, may be programmed by either a voltage or a current (and in the latter case the programming current may directly set the OLED current by driving the OLED with a scaled version of the programming current).

The brightness of an OLED is determined by the current flowing through it, which determines a number of photons it provides. Thus the brightness-current curve of an OLED is broadly linear whereas the brightness-voltage curve is strongly non-linear. Thus with a voltage-programmed circuit, because the characteristics of the OLEDs, and also of the driver transistors, vary across the display and with temperature, time and age it is difficult to predict how bright a pixel will appear when driven by a given voltage. Related difficulties arise because transistors of a pixel driver circuit can suffer from matching issues. Although this latter problem can be addressed by transistor threshold voltage compensation, and by the use of carefully matched transistors, this increases the area of a pixel driver circuit and does not fully solve the problems (the circuits can still suffer from voltage droop).

A solution to these problems is to employ a current-programmed pixel driver circuit such as a current-copier circuit, which provides a good linear brightness response, substantially irrespective of variations of the characteristics of the OLED and pixel driver transistors. Current programmed circuits are also good at providing accurately matched performance between pixels. However current programmed pixel driver circuits suffer from their own problems and, in particular, they can be slow to program due to parasitic capacitance. It is also difficult to achieve a wide dynamic range. This is particularly a problem for high definition television (HDTV) where the data line lengths to pixel driver circuits can be large and where the high dynamic range imposed by the standards can result in very small programming currents, potentially for orders of magnitude below 1 μA for a minimum grey-level current. Especially at low luminance levels, where the currents are small, accurate control is difficult.

A voltage programmed circuit is a potential solution to these problems since voltage program circuits enable fast programming and a wide dynamic range. However these suffer from other problems, as previously mentioned. New active matrix backplane fabrication techniques, in particular the use of chiplets (described further later), have however facilitated alternative approaches.

### SUMMARY OF THE INVENTION

According to the present invention there is therefore provided a pixel driver architecture for an active matrix OLED display, the pixel driver architecture comprising: a voltage-programmed master pixel programming circuit, said master pixel programming circuit being configured to produce a programmable current in response to programming voltage, wherein said master pixel programming circuit comprises a voltage programming line to receive a programming voltage defining a pixel luminance, a programmable current generator coupled to said voltage programming line to generate a programmed current responsive to said programming voltage, and a current output line to output said programmed current; and a first plurality of current-programmed slave pixel driver circuits, each coupled to said master pixel programming circuit, and each configured to drive a respective OLED responsive to a said programming voltage received by said master pixel programming circuit, wherein a said slave pixel driver circuit comprises a current programming line coupled to said current output line of said master pixel programming circuit, an OLED current driver circuit having an OLED drive output to drive an OLED with a current programmed by said programmed current output from said master pixel programming circuit, and a pixel select line to select said current driver circuit for programming by said programmed current output.

Preferred embodiments of the above described architecture combine the desirable features of both voltage-programmed and current-programmed circuits while ameliorating their respective problems. This is done, broadly speaking, by using a voltage-programmed reference circuit to program, with a current, a plurality of local slave circuits. In this way the fast programming and wide dynamic range of voltage programmed circuits can be combined with the well-matched performance of multiple current-programmed sub-or slave-circuits.

In embodiments the master pixel programming circuit includes a threshold voltage compensation circuit to compensate for threshold variation in an output transistor providing the programmed current driving the slave circuits. In embodiments this may be implemented by one or more additional control lines to null out the threshold voltage, for example by storing an offset voltage to apply to the programming voltage on a capacitor. In embodiments sensitivity of the master pixel programming circuit to voltage droop may be reduced by employing an independent reference voltage for (the current drive from) this circuit, which may be a power supply line such as V_{SS} or ground.

Optionally the master pixel programming circuit may have a control or power supply line to reduce a bias voltage on the output transistor when the circuit is not in use, to reduce ageing. Thus in embodiments, when averaged over time, there may only be a small bias voltage used in this circuit.

The master pixel programming circuit may also be provided with a current return line. For example, rather than the current output of the master pixel programming circuit connecting to a power supply rail, the return line may be brought out from the circuit, to facilitate current sensing. Then a closed loop control system may be employed to adjust the programming voltage in response to the sensed programmed output current, in order that the output current may be servoed to a desired target value.

In embodiments the one or more transistors of one or both of the master and slave circuits may be n-channel transistors. This is because the above described circuit architecture circumvents the problems normally associated with the use of n-channel devices: if an n-channel device is used to drive an OLED then the OLED is connected to the source of the transistor, and because the gate-source voltage programs the drive current, variations in the OLED threshold voltage (and transistor threshold voltage) can affect the drive current. The above described voltage-programmed master plus current-copying slave circuits circumvents this issue architecture (noting that ‘copying’ does not necessarily imply 1:1 ratio copying). Thus although embodiments of the above described architecture are particularly suitable for use with chiplet-based backplanes, the architecture also has significant advantages for amorphous silicon backplanes, in particular because it mitigates the ageing issues and limitations of n-channel TFTs. In embodiments, therefore, all the transistors in the master and/or slave circuits may be n-channel devices.

In embodiments a cascode transistor may be connected between the current output line of the master pixel programming circuit and the current programming line of each slave pixel driver circuit. Thus the drain/source connection(s) of the/each cascode transistor are connected in series between the master and slave circuits and the gate may be connected to a bias voltage. Broadly speaking, the use of a cascode transistor stabilizes the voltage on the current output line of the master pixel programming circuit (which may be a current source or a current sink), in effect reducing the output impedance of the master circuit. This reduces voltage variations on the current programming line, and hence decreases programming time. Preferably a high transconductance device (with a relatively wide channel) is employed. Optionally this device may be “distributed” among the slave circuits, as described in detail later.

In embodiments the architecture also includes a controller to control the master and slave circuits to program each of the slave circuits in turn. Thus in embodiments the controller controls the master circuit to generate a programmed current for a slave circuit, selects the appropriate slave circuit to program the circuit, allows time for the current-programmed slave circuit to settle, and then repeats the procedure. Such a controller may be provided as part of an active matrix display, or externally separate from the display.

Embodiments of the above described architecture may also be advantageously employed in a stereoscopic OLED display, for fast switching between alternate left and right eye images (in conjunction with shutter glasses). In such a system two sets of slave pixel driver circuits are provided for each master and one set is programmed while the other is displayed. The display can be switched almost instantly from one stereoscopic image to another by switching the OLEDs so that they are driven by one or other set of slave pixel driver circuits. This in turn reduces flicker and, in principle, increases lifetime (further details can be found in our GB1101267.1 filed on 25 Jan. 2011).

Thus in embodiments the slave pixel driver circuits are paired, each pair of circuits sharing a common OLED drive line. Provision is then made for switching between the paired slave circuits to drive the OLED. This may be achieved by an additional drive select line or, more simply, by providing separate power supply (V_{DD}) lines to each slave driver circuit of the pair, each having its own respective select line for programming. Then one slave driver circuit may be programmed while the other is driving the OLED, and vice versa.

Embodiments of the architecture may have just a single master pixel programming circuit for the entire display (or for a block/region of the display) or, say, one master circuit for each row (or column) of the display. However in preferred embodiments there is a plurality of master pixel programming circuits each with a respective set of slave circuits. Preferably one or both of the master and slave circuits is fabricated on a chiplet. Such a chiplet comprises an integrated circuit, typically on a silicon substrate, bearing the master and/or slave circuits. The chiplet may have separate connections to each of the pixels of the group, for controlling the individual pixels in accordance with the programming voltages received by the master circuit. The chiplets may be distributed over the display substrate and may have one or more common serial or parallel input data connections (that is, the voltage programming line of the master circuit may be an internal, rather than an external, connection for a chiplet). Thus each chiplet may be associated with a group of two or more pixels, typically less than 50 pixels, to provide the pixel driver architecture for the group of pixels. A chiplet may advantageously be mounted adjacent or among the group of pixels which it drives. Thus, in embodiments, the chiplets may be distributed over the 2D area of the display.

It will be appreciated that, in general, the number of voltage programming lines and the number of pixel select lines may be traded against one another. However, in embodiments, a product of these two values is at least equal to a number of OLEDs driven by the pixel driver architecture. (Again, ‘pixel’ may refer to a color sub-pixel of the display).

The above described pixel driver backplane architecture may be combined with a substrate bearing a plurality of OLED pixels to provide a complete active matrix OLED display, preferably a full color display.

In a related aspect the invention provides a method of driving an OLED display, the method comprising: providing a voltage-programmed master pixel programming circuit comprising a voltage-programmed current generator; providing a plurality of current-programmed slave pixel driver circuits, each configured to drive an OLED with a current programmed by a current on a current programming line; connecting the current programming lines of each of said slave pixel driver circuits to provide a shared current programming line; programming said master pixel programming circuit with a voltage to generate a programmed current from said current generator; programming a selected one of said slave pixel driver circuits by providing said programmed current from said current generator of said master pixel programming circuit to said shared current programming line; driving an OLED connected to one of said selected slave pixel driver circuits with a current programmed by said voltage programming said master pixel programming circuit; and repeating said programming of said master pixel programming circuit and of said selected one of said slave pixel driver circuits to program an OLED drive current for each of said slave pixel driver circuits.

The invention further provides an OLED display comprising: a voltage-programmed master pixel programming circuit comprising a voltage-programmed current generator; a plurality of current-programmed slave pixel driver circuits each configured to drive an OLED with a current programmed by a current on a current programming line; a shared current programming line connecting the current programming lines of each of said slave pixel driver circuits; means for programming said master pixel programming circuit with a voltage to generate a programmed current from said current generator; and means for programming a selected one of said slave pixel drive circuits by providing said a programmed current from said current generator of said master pixel programming circuit to said shared current programming line; and means for driving an OLED connected to one of said selected slave pixel driver circuits with a current programmed by said voltage programming said master pixel programming circuit.

Preferably the OLED display also includes a controller, as previously described.

### BRIEF DESCRIPTION OF THE DRAWINGS

These and other aspects of the invention will now be further described, by way of example only, with reference to the accompanying figures in which:

FIGS. 1a to 1c show, respectively, first and second examples of a pixel driver architecture according to an embodiment of the invention, and an illustration of a portion of an OLED display including a chiplet integrated circuit;

FIGS. 2a to 2c show, respectively, portions of an OLED display incorporating chiplets implementing a pixel driver architecture according to an embodiment of the invention, and a further example of a pixel driver architecture according to an embodiment of the invention;

FIGS. 3a and 3b show examples of controllers for pixel driver architectures according to embodiments of the invention;

FIGS. 4a to 4c show, respectively, an example of a voltage-programmed master pixel programming circuit in combination with digital input circuitry, and a slave driver circuit state decoder for implementation on a chiplet, an example of an n-channel only voltage-programmed master pixel programming circuit, and an example of transistor threshold voltage compensation according to the prior art; and

FIGS. 5a to 5e show, respectively, current-programmed slave pixel driver circuits, an n-channel only slave pixel driver circuit, a stereoscopic pixel driver architecture for a 3D active matrix display, paired slave pixel driver circuits for a stereoscopic display, and slave pixel driver circuits incorporating a distributed cascode transistor.

### DETAILED DESCRIPTION OF PREFERRED EMBODIMENTS

### Pixel Driver Architecture

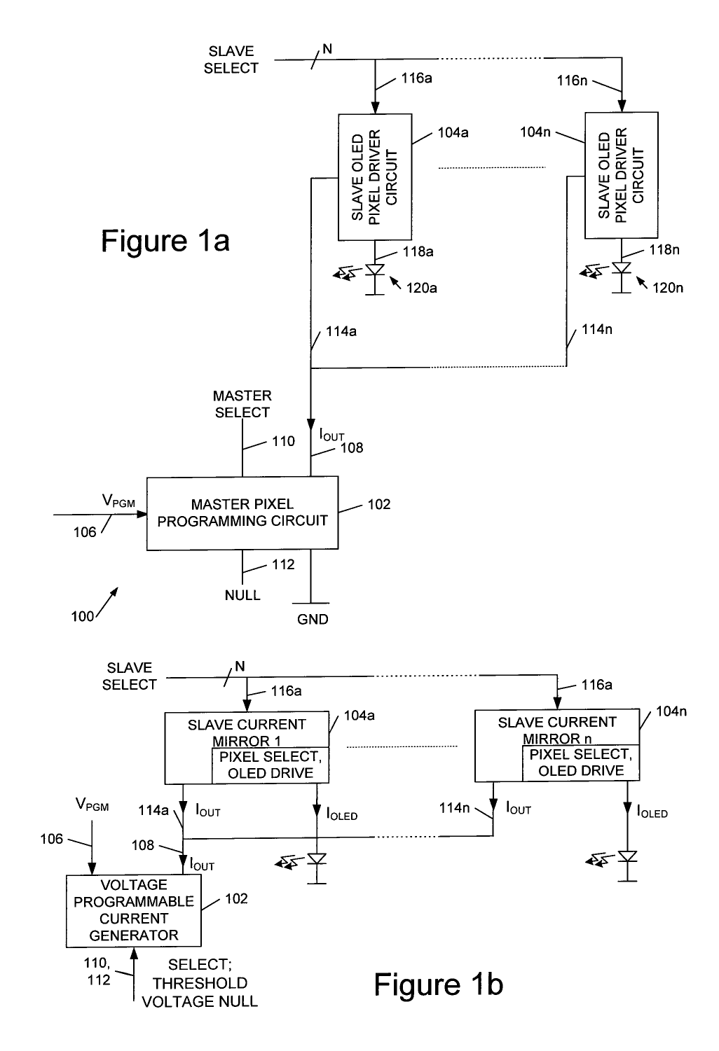

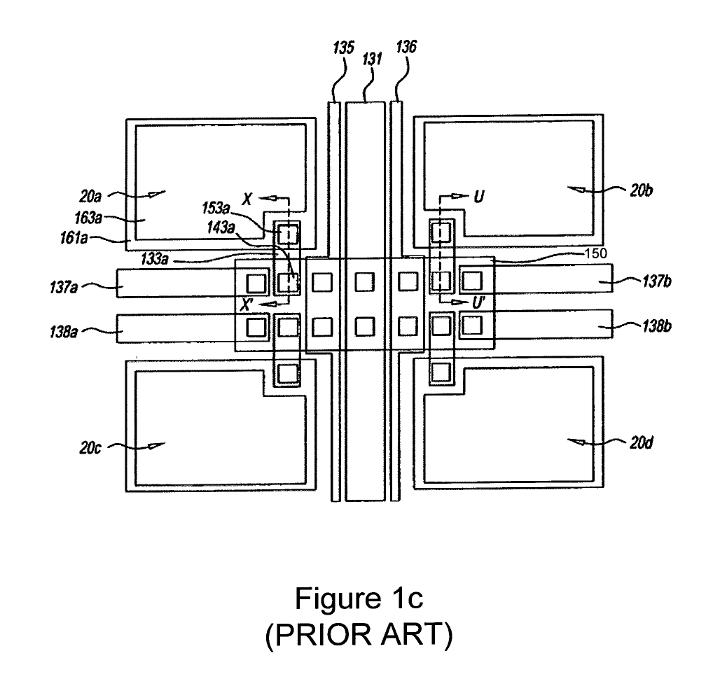

Referring to FIG. 1a, this shows an embodiment of a pixel driver architecture 100 according to the invention comprising a voltage-programmed master pixel programming circuit 102 coupled to a plurality of current-programmed slave pixel driver circuits 104a-n. The master circuit 102 has a voltage programming line 106 to receive a programming voltage and provides a programmed current on a current output line 108 controlled by the input voltage. Optionally the master pixel programme circuit also includes a select line 110 and a null control line 112, the latter for nulling a threshold voltage on an output transistor of the circuits. Each slave pixel driver circuit has a current programming input line 114a-n and a respective select line 116a-n and has an OLED drive output 118a-n to drive a respective OLED 120a-n.

FIG. 1b shows an example of the circuit of FIG. 1a in which each slave pixel driver circuit is implemented by a current mirror which, in embodiments, provides a current-copying function to copy the output current from the master pixel programming circuit to the OLED. The skilled person will understand that the ratio of the programming to the OLED current may be changed by changing the ratio of the number of input transistors to output transistors or, equivalently, a ratio of the size (channel width/length) of the input transistor to the output transistor.

In embodiments one or both of the master and slave circuits may be constructed from transistors (TFTs) which are n-channel only. Where a TFT circuit is employed the master pixel programming circuit may include TFT threshold voltage compensation. In embodiments the master pixel programming circuit 102 lacks a storage capacitor because this is not needed as the circuit is actively driven only when the slave pixel driver circuits are programmed. As illustrated the master pixel programming circuit provides a current sink to Vss (ground), which is convenient for n-channel transistors.

Each of the slave OLED pixel driver circuits 104 is programmed by the current output of the master circuit 102 when selected by pixel select line 116. A slave circuit reproduces the output current from the master circuit (or a multiple or fraction of this) as a source current for the OLED 120 it drives, with the programmed current being held for a frame time by a storage capacitor.

In operation, an example programming sequence is as follows:

1. The threshold voltage compensation portion of the master pixel programming circuit is activated to null the threshold voltage.

2. The programming voltage for the first pixel is applied to the voltage programming line 106 and the master programming circuit 102 starts sinking the programmed current.

3. The select line for the first slave driver pixel circuit is asserted, causing the sink current to be applied to the current copier (current mirror) or other current input stage of a current-programmed OLED driver circuit.

4. The slave pixel driver (current copier) circuit settles until it is correctly outputting the programmed current.

5. The select line is de-asserted.

6. Steps 2-5 are repeated for each slave pixel driver circuit 104.

7. Depending upon the configuration of the slave pixel driver circuit, if they are not already driving their associated OLED pixels (color sub-pixels) the slave driver circuits are controlled to drive their respective OLEDs (this may be implemented by controlling the power supply to the slave pixel driver circuits).

8. Optionally the master pixel programming circuit is set to a state whereby, as other (master) circuits are programmed, there is on average only a small bias voltage (in the circuit). This may be achieved, for example, by removing a power supply to the master pixel programming circuit following programming of its slave circuits.

Typically there are multiple master pixel programming circuits, each with a set of slave pixel driver circuits, in which case the above procedure is repeated for each master circuit. Depending, for example, on the number of data lines provided the master circuits may be programmed either serially or in parallel or in some serial/parallel combination.

Depending on the configuration of the slave pixel driver, and the desired operation of the architecture, each slave pixel driver circuit may drive its associated OLED immediately after it has been programmed.

In embodiments, only a relatively small number of slave pixel driver circuits are connected to each master programming circuit—for example there may be less than 50 slaves to each master, in one example implementation 12 slaves to each master (four sets of three different colored sub-pixels). Because of this step 4 above, in which the current output of a slave pixel driver circuit settles, can be relatively fast. This is unlike an architecture in which a pixel is current-programmed via a long line from the edge of the display, where the copying step can be very slow due to line capacitance, resistance, and a large number of circuits connected to each programming line.

Furthermore, because in embodiments the master circuit is operated only during the programming of its associated slave circuits, if the master circuit is implemented in amorphous silicon the ageing of this circuit can be very substantially reduced. Furthermore, what ageing there is may be compensated for by nulling the threshold voltage. Although, in amorphous silicon embodiments, the slave pixel driver circuits will age, these current-programmed (current-copying) circuits are effectively self-compensating so long as there is sufficient voltage overhead at the copying stage—that is so that there is sufficient voltage overhead for the programmed current to be delivered. This can be easily achieved by increasing the power supply voltage, more particularly by reducing Vss below zero volts.

### Chiplets

Some preferred implementations of the embodiments of the invention use chiplets to implement the pixel driver architecture. In broad terms these chiplets comprise small silicon integrated circuits which are stuck onto the glass substrate of a display and connected to OLED pixels and to external connections of the display. To aid in understanding embodiments of the invention we will now briefly describe details of such chiplets.

FIG. 1c which is taken from WO 2010/019185 shows a layout view of a group of four pixels (20a, 20b, 20c and 20d) elements of an OLED display device. Each of the four pixels can be arranged to emit a different color, such as red, green, blue and white (RGBW). FIG. 1b represents a portion of a full display where the full display would be constructed of an array of such groups of pixels arranged in many rows and columns. For example, a modern television would be constructed having 1920 rows and 1080 columns of such groups of pixels.

A chiplet 150 is arranged to control the electrical current to pixels 20a, 20b, 20c and 20d. A chiplet is a separately fabricated integrated circuit which is mounted and embedded into the display device. Much like a conventional microchip (or chip) a chiplet is fabricated from a substrate and contains integrated transistors as well as insulator layers and conductor layers which are deposited and then patterned using photolithographic methods in a semiconductor fabrication facility. These transistors in the chiplet are arranged in a transistor drive circuit to drive the electrical current to pixels of the display. A chiplet is smaller than a traditional microchip and unlike traditional microchips, electrical connections need not be made to a chiplet by wire bonding or flip-chip bonding. Instead, after mounting each chiplet onto the display substrate, deposition and photolithographic patterning of conductive layers and insulator layers continues. Therefore, the connections can be made small, for example through using vias 2 to 15 micrometers in size. The chiplet and connections to the chiplet are small enough to be placed within the area of one or more pixels which, depending on the display size and resolution, may range from approximately 50 micrometers to 500 micrometers in size. Additional details about the chiplet and its fabrication and mounting processes can be found in WO '185.

Each pixel is provided with a lower electrode, such as a lower electrode 161a in pixel 20a. The emitting area of pixel 20a is defined by an opening 163a in an insulator formed over the lower electrode. The device includes multiple conductive elements formed in a first conductive layer which are arranged to facilitate providing electrical signals to the chiplet's transistor drive circuitry to enable the chiplet to control electrical current to the pixels. Chiplet 150 controls current to pixel 20a through a conductor 133a. For example, conductor 133a is connected to chiplet 150 through a via 143a and is also connected to lower electrode 161 a through a via 153a. The device also includes a series of signal lines including, power lines, data lines, and select lines which are formed in the first conductive layer and transmit electrical signals from the edge of the display to the chiplets. Power lines are signal lines that provide a source of electrical current to operate the organic electroluminescent elements. Data lines are signal lines which transmit bright information to regulate the brightness of each pixel. Select lines are lines which selectively determine which rows of the display are to receive brightness information from the data lines. As such select lines and data lines are routed in an orthogonal manner.

Power is provided to the chiplet 150 by way of a power line 131. Two vias are provided for connection between the power line and the chiplet 150. A data line 135 is provided in the column direction for communicating a data signal containing brightness information to chiplet 150 for pixel 20a and pixel 20b. Similarly, a data line 136 is provided in the column direction for communicating a data signal containing brightness information to chiplet 150 for pixel 20b and pixel 20d. In an alternate arrangement the data lines 135 and 136 and the power line 131 can be connected to the chiplet 150 by only a single via for each line. A select line segment 137a is provided in the row direction for communicating a row select signal to chiplet 150 for pixel 20a and pixel 20b. The row select signal is used to indicate a particular row of pixels and is synchronized with the data signal for providing brightness information. Thus the row select signal and the data signals are provided in orthogonal directions. Chiplet 150 communicates the row select signal from select line segment 137a to a select line segment 137b by way of an internal pass-thru connection on the integrated circuit. Select line segment 137b then communicates the row select signal to subsequent chiplets arranged in the same row. Similarly a select line segment 138a is provided in the row direction for communicating a row select signal to chiplet 150 for pixel 20c and pixel 20d. Chiplet 150 communicates the row select signal from select line segment 138a to a select line segment 138b by way of another internal pass-thru connection on the integrated circuit. Select line segments 137a and 137b together serve to form a single select line, which is discontinuous. Connections between the select line segments are provided by the pass-thru connections in the chiplet. While only two segments are shown, the select line can contain a series of many such segments. Select line segments 138a and 138b similarly together serve to form a single discontinuous select line. All of the select lines segments and data lines may be formed from a single metal layer. Communication across the orthogonal array is then achieved by routing either the row select signal, the data signal, or both through the pass-thru connections on the chiplet.

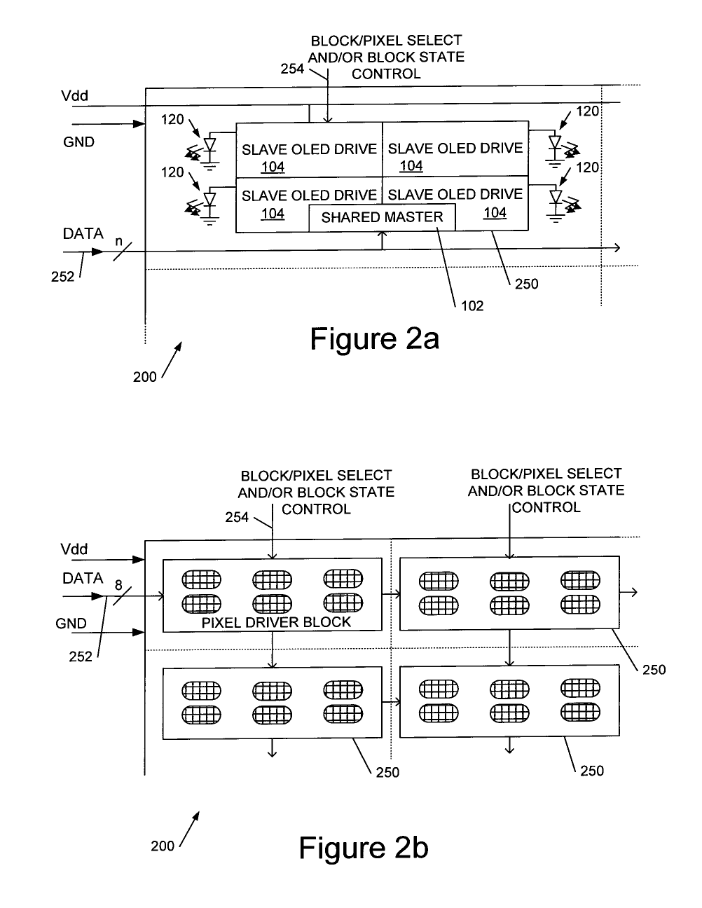

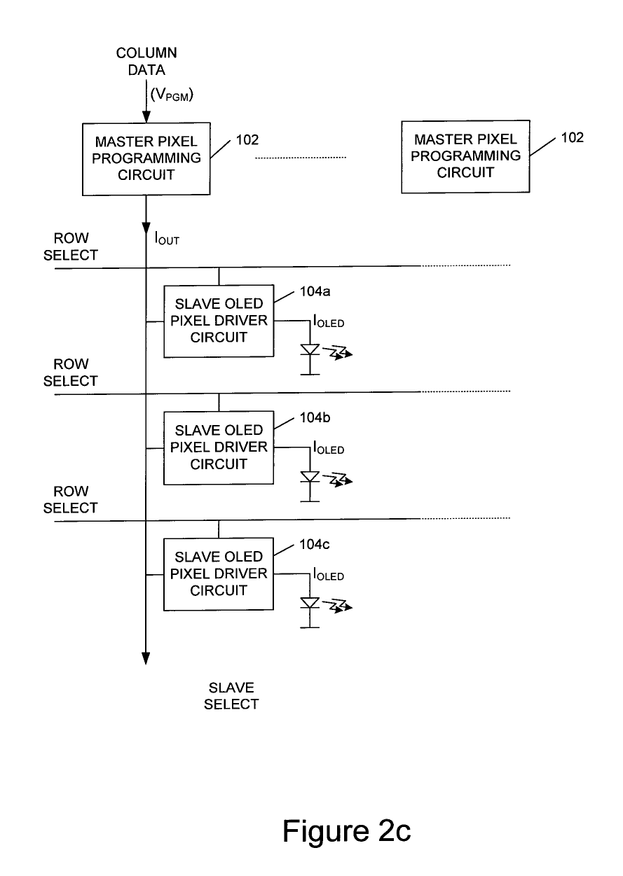

Referring now to FIGS. 2a and 2b, the pixel driver architecture of FIG. 1 may be implemented on one or more chiplets 250 mounted on an OLED display 200. Thus a chiplet 250 may comprise a master pixel programming circuit 102 and a set of slave pixel driver circuits 104 together with, optionally, additional circuitry for addressing/controlling the architecture. Thus, for example, a set of chiplets may share a digital data bus 251 to receive data for defining a programming voltage on voltage programming line 106 of a master circuit. Similarly a set of slave pixel driver circuits may share a control bus 254 which is decoded on the chiplet to determine control states for the architecture, for example for threshold compensation and/or slave circuit selection and/or blanking/driving the associated OLEDs.

FIG. 2a shows a single chiplet on a portion of an OLED display 200 with (for ease of illustration) four slave circuits. FIG. 2b shows a zoomed-out view of a similar OLED active matrix display in which each chiplet drives 6 pixels, also illustrating daisy-chained inter-chiplet communication.

FIG. 2c illustrates a further example of the architecture in which a master programming circuit is provided for each column of the display, and in which row select lines are used to select the slave pixel driver circuits coupled to each master. Alternatively there may be multiple row selects for different subsets of pixels, or some other combination of voltage data lines and pixels group select lines. In general the product of the number of data lines multiplied by the number of pixel select lines is equal to at least the total number of pixels (sub-pixels).

### Architecture Control

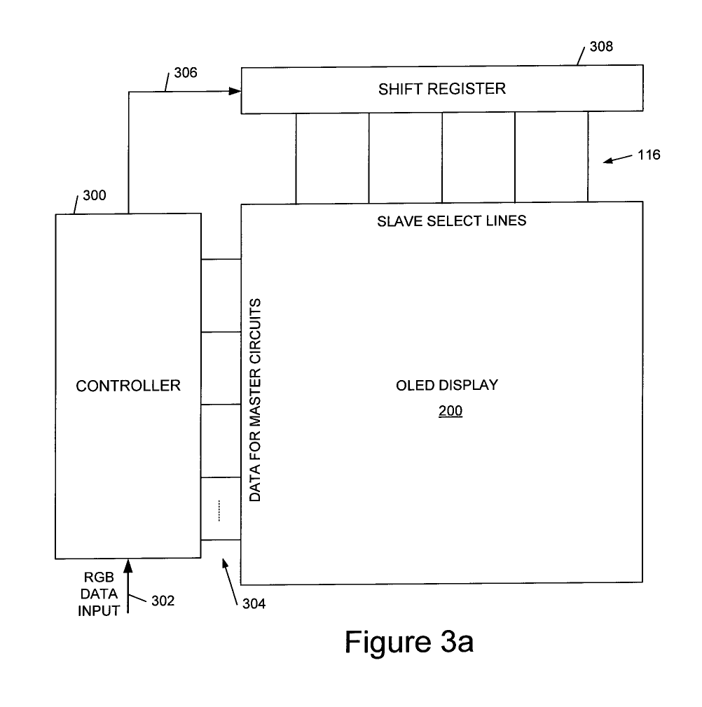

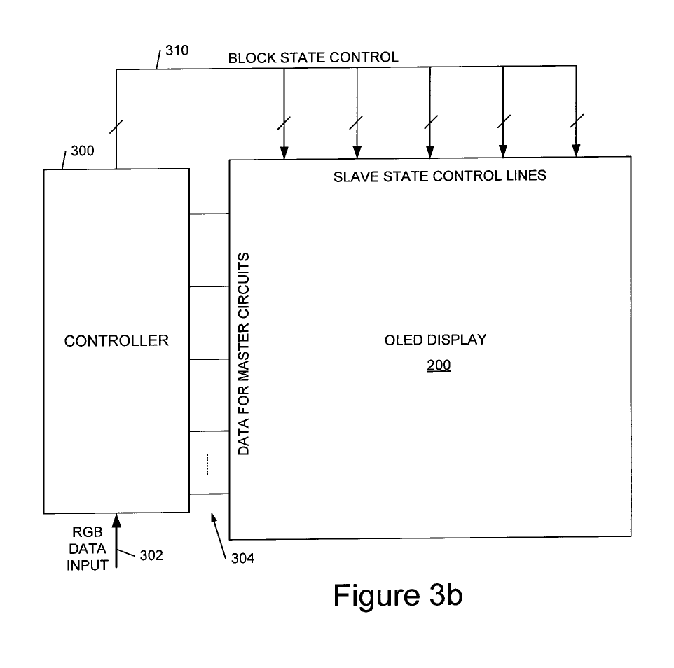

FIG. 3a illustrates an active matrix OLED display as described above coupled to a controller 300 configured to implement a programming sequence as previously described. Thus the controller inputs color (RGB) data on line 302 and provides a set of data output lines 304 (either digital or analogue) to provide programming voltages to program the master pixel circuits of the display 200. In the illustrated example the controller also provides a clock output 306 to a shift register 308 which has outputs to control the slave pixel driver circuit select lines 116.

The skilled person will appreciate that there may be many variations of the pixel driver architecture control techniques. For example with a chiplet-based architecture implementation an arrangement of the type shown in FIG. 3b may be employed in which controller 300 outputs block state control data on a bus 310 which is decoded to control the driver architecture on each chiplet.

### Architecture Implementation Details

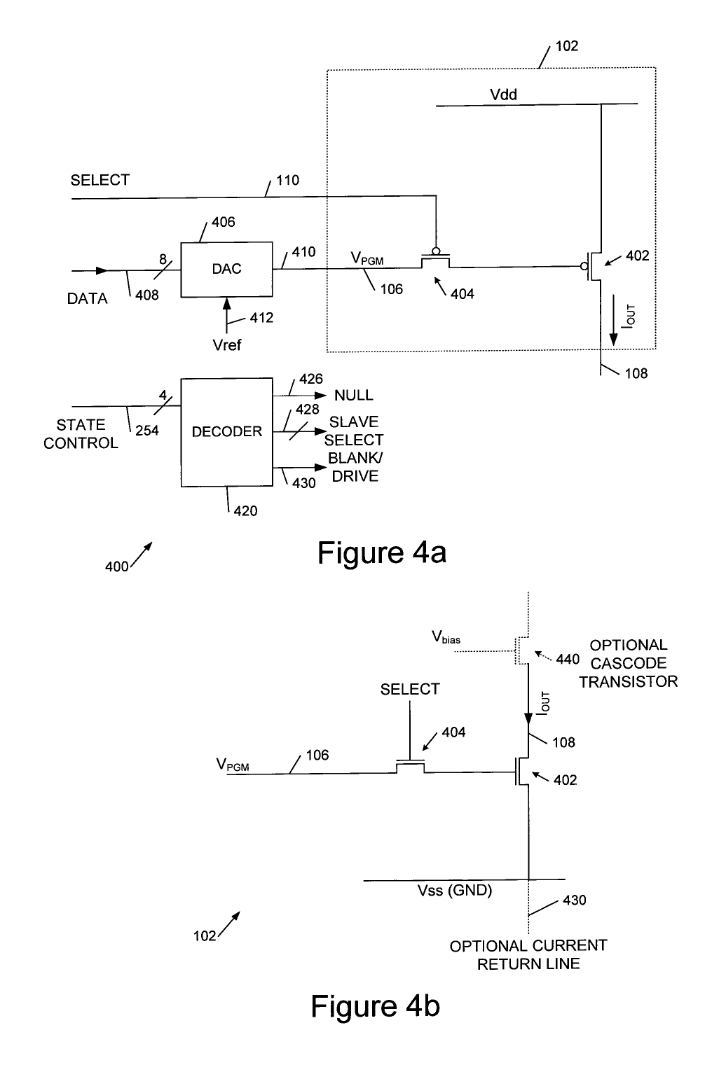

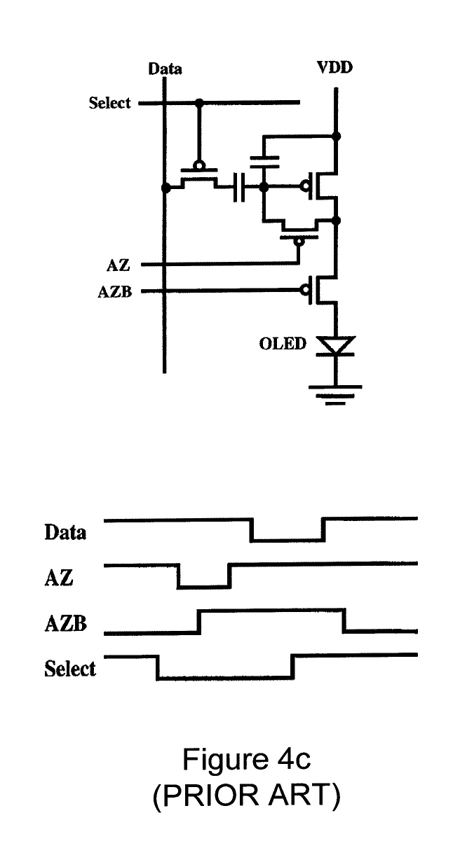

Referring now to FIG. 4a, this shows details of an example master pixel programming circuit 102 implemented on a chiplet and incorporating additional control circuitry to provide a master pixel programming system 400. The master programming circuit 102 comprises an output transistor 402 coupled between the current output line 108 and a power supply line, in this example Vdd. The gate of transistor 402 is coupled, via a select transistor 404, to voltage programming line 106, transistor 402 acting as a voltage-to-current converter. Thus the transistor 402 is only biased when driven. A storage capacitor could be coupled between Vdd and the gate of transistor 402, but this is not needed because the master circuit only needs to provide its programmed output current when the slave circuits are being programmed.

The system 400, in this example, also includes a digital-to-analogue converter 406 to accept a digital data input 408 and provide a voltage output 412 for programming the master circuit 102, based on a reference voltage input 412. Optionally DAC 406 may be shared between multiple master pixel programming circuits. As illustrated the system also includes a decoder 420 to receive digital state control data on input 254 and to provide a set of outputs 422 comprising, in this example, a null control output 426, a set of slave circuit select outputs 428, and a blank/drive output 430. Decoder 420 receives a digital input and demulitplexes the set of state lines. For example in a case where there are 12 slave pixels states 0 and 1 may be employed to set up the threshold compensation, states 2 to 13 may be employed to program the slave circuits, and states 14 and 15 may be used to blank prior to driving and for pixel driving. Thus all these states can be implemented with 4 data lines decoding to 16 lines internally to the chiplet.

FIG. 4b shows a variant of the master circuit 102 employing n-channel transistors. This circuit further illustrates that rather than transistor 402 connecting directly to ground a current return line 430 may be provided to sample the output current from the master circuit, for example for use in a feedback loop to provide a further level of circuit characteristic compensation.

FIG. 4b also illustrates the use of an optional cascode transistor 440 coupled between the current output of the master circuit and the current programming line of the slave circuits. This transistor stiffens the voltage on the current programming line of the slave circuits. It may be driven by a preset local bias circuit; the bias voltage may be selected so that the cascode transistor is held (just) in an on-state to provide a channel to the slave circuits. For an n-channel device the voltage on the slave circuit's current programming lines is thus held at, approximately, a threshold voltage less than the applied bias voltage. A cascode transistor connected between the master pixel programming circuit and the slave pixel driver circuits is particularly useful for a chiplet implementation, to aid better matching.

FIG. 4c shows an example threshold voltage compensation circuit of the type which may be employed in a master pixel programming circuit 102 such as that described above. The waveforms illustrate the operation of the circuit. Broadly speaking the circuit is activated and then allowed to discharge itself leaving the threshold voltage of the output transistor stored on the capacitor connected in series between the gate of the output transistor and the data input line, thus offsetting the programming voltage on the data input line when this is applied to the gate of the output constant current generator.

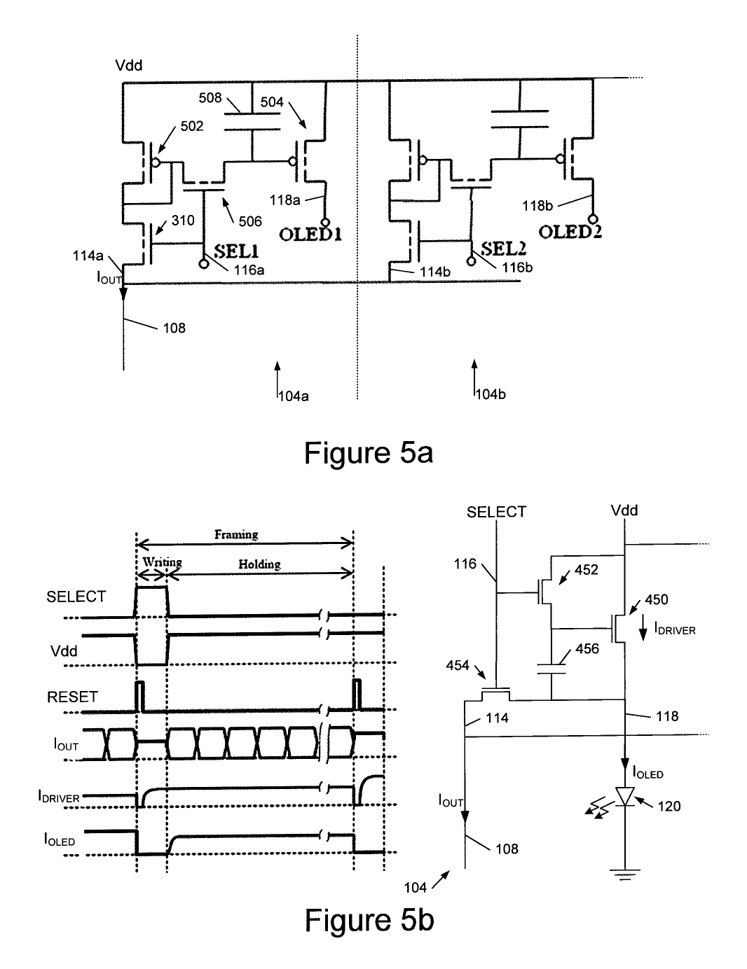

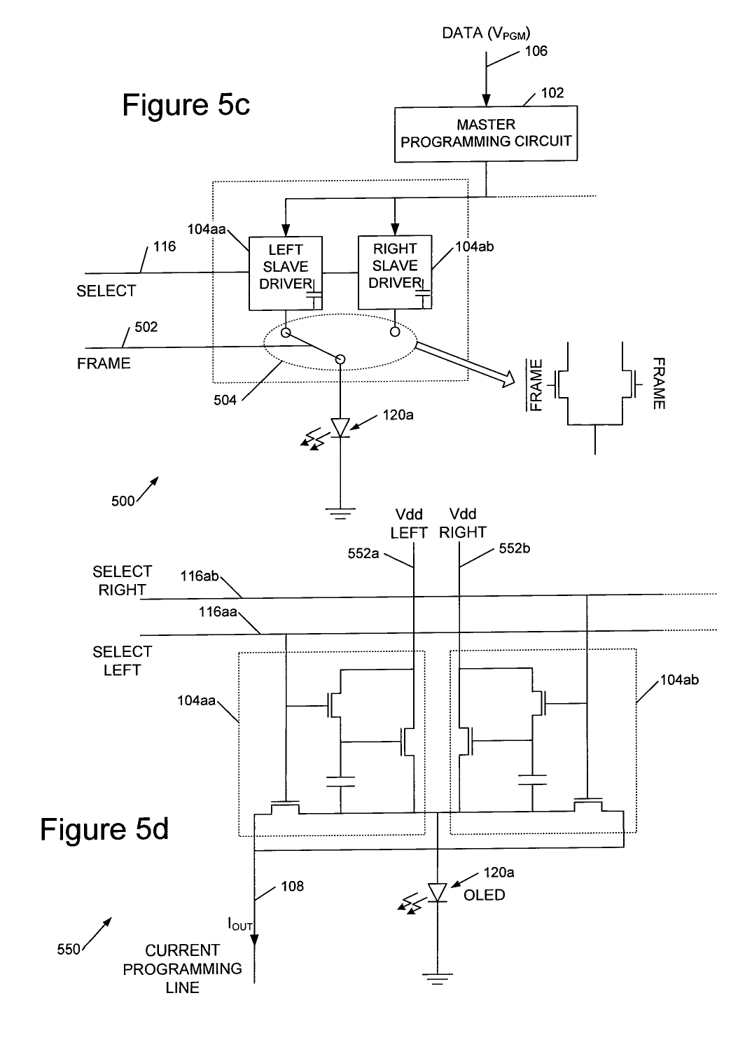

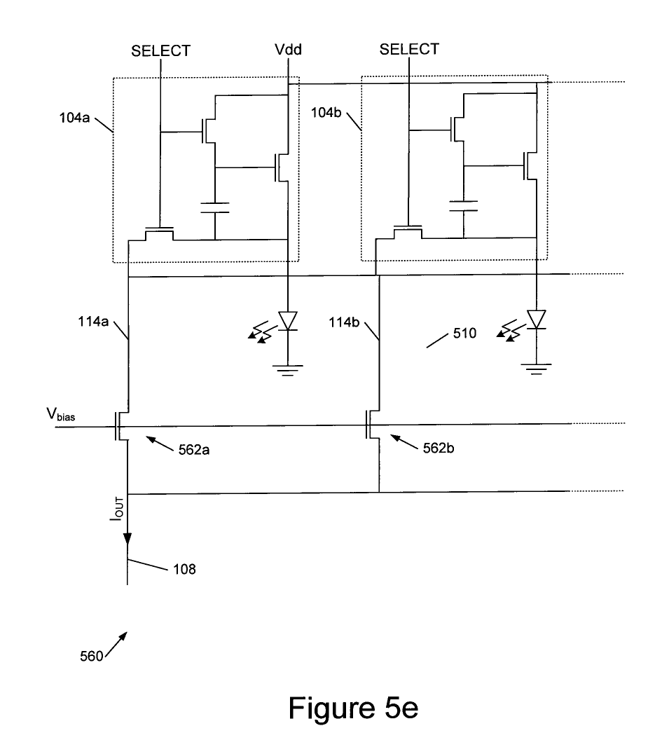

FIG. 5a illustrates an example set of slave pixel driver circuits 104a, b, in this example each comprising a current-copying current mirror circuit. Thus, for example, slave pixel driver circuit 104a has a current mirror comprising an input transistor 502 and an output transistor 504 to provide a drive current on OLED drive line 118a. The input transistor 502 is selectively connected to the current programming line 114a by a pair of select transistors 506 and the operation of the current mirror programmes a voltage onto capacitor 508 which copies the current on line 114a to the OLED driven by line 118a.

FIG. 5b illustrates an alternative embodiment of a slave pixel driver circuit 104, in this example using n-channel transistors. In this circuit a pixel driver transistor 450 has a (source) connection 450 to OLED drive line 118 and OLED 120. The current through transistor 450 is programmed by a pair of select transistors 452, 454, transistor 452 diode-connecting driver transistor 450 and transistor 454 coupling the source of transistor 450 to the current programming line 114. In operation the current through transistor 450 is set by the current sunk on line 114 and a capacitor 456 connect to the gate of driver transistor 450 memorizes the driver transistor gate voltage required for the set drain-source current of transistor 450.

Optionally an additional select transistor (switch) may be coupled in series between OLED drive output 118 and OLED 120, controlled by an inverted version of the select signal on line 116. Then, when this switch is open, and the circuit is being programmed, the drain-source current through transistor 450 flows via lines 114, 108 into the current sink provided by the master pixel programming circuit. Such a transistor may also be employed to provide an OLED-blank function. However it is not necessary to use a transistor connected in series with the output in this way and instead, for example, the programming of the circuit can be controlled by controlling the power (V_{dd}) line, as illustrated by the inset waveforms. In this case (that is, with the circuit as illustrated) a reset transistor may be provided on line 508 (not shown in FIG. 5b), common to the set of slave circuits, to selectively ground line 108 on application of a voltage V_{Reset}. Such a transistor may therefore be connected between line 108 and ground. Then in operation (and referring to the inset waveforms), in a first stage line 108 is briefly grounded to discharge capacitor 456 and the junction capacitance of the OLED (SELECT is high, the RESET signal is pulsed high, and the power supply, Vdd is low). Then the programming current from the master pixel programming circuit is applied so that a corresponding current flows through transistor 450 and capacitor 456 stores the gate voltage required for this current (the power supply V_{dd} is low so that no current flows through the OLED, and transistor 452 is on so that driver transistor 450 is diode-connected. Finally the SELECT line is de-asserted and the power supply line, Vdd is taken high so that the programmed current (as determined by the gate voltage stored on capacitor 456) flows through the OLED 120.

A variant of the above described pixel driver architecture can advantageously be employed for a stereoscopic, 3D active matrix OLED display. FIG. 5d shows an example of a stereoscopic pixel driver architecture 500 comprising left and right slave pixel driver circuits 104aa, 104ab each with a respective select line 116 and programmed by a common master pixel programming circuit 102. The architecture of FIG. 5c illustrates a pair of slave pixel driver circuits for just one pixel; this is replicated for each pixel.

A frame select line 502 controls a switch 504 to selectively couple one or other of the pair of slave pixel driver circuits to a common, shared OLED 120a. Switch 504 may be implemented as shown by the inset (or alternatively, for example, using one n lower and one p switching transistor). The left slave pixel circuits store brightness data for a left stereoscopic image, and the right slave driver circuits store brightness data for a right stereoscopic image. The frame select line enables the drive to be switched very rapidly between drive data for the left and right stereoscopic images. In operation the select lines 116 and frame line 502 are controlled such that one of the slave pixel driver circuits drives the OLED pixel while the other is being updated with pixel brightness data. Optionally, however, the frame control signal may be switched between the left and right slave pixel driver circuits faster than the rate at which data is written to the left or right pixel drivers. This is because the circuit architecture provides that the left eye sees only the left image frames, either complete or being updated, and vice versa so that there is no mixing of left and right image data in the stereoscopic display for one or other eye. For further details reference may be made to our co-pending UK patent application number 1101267.1 filed on 25 Jan. 2011.

Referring now to FIG. 5d, this shows an example implementation of a stereoscopic pair of slave pixel driver circuits 550, each of the general type illustrated in FIG. 5b. The illustrated example circuit has separate left and right Vdd power supply lines 552a, b to the left and right slave pixel driver circuits 104aa, 104ab, using these to control the drive to OLED 120a. The V_{dd} line for a slave pixel driver circuit is taken low when that circuit is programmed. Thus in a preferred mode of operation one of the slave pixel driver circuits is programmed while the other is driving the OLED pixel, and vice versa (which can mean that with a succession of image frames a left or right image may in fact show parts of two successive frames. In operation, when programming one of the left/right select lines is asserted and the corresponding left/right V_{dd} line is disconnected (switched open circuit); when driving the select line is de-asserted and power is applied.

Thus, broadly speaking, embodiments of the pixel driver architecture may include duplicate output stages (slave pixel driver circuits) acting as frame buffers. A first set of the slave pixel driver circuits (say, left) drives the display while the second set of circuits (say, right) is programmed, and then the drive level is asserted globally switching the output of the whole panel from the first set to the second set. The first set is then programmed for the next frame while the second set is being driven. In this way left and right eye images can be alternated cleanly without the risk of shearing cross-talk and with a maximum OLED duty cycle (that is without the need for a blanking interval between left and right frames).

FIG. 5e shows a further example of a pixel driver architecture 560 which employs a distributed cascode transistor for the slave pixel driver circuits. This arrangement may be employed with or separately from the cascode transistor of FIG. 4b associated with the master pixel programming circuit. In FIG. 5e each slave pixel driver circuit has an associated cascode transistor 562a, b. The drain connections, the source connections, and the gate connections of these cascode transistors are connected in parallel to provide, in effect, a single, distributed transistor with a wide channel and thus a high transconductance. This provides improved cascode functionality without the need for a single very ‘fat’ transistor. The parallel-connected gates are, in embodiments, connected to a bias voltage line which may be either a local connection or a global connection for the display panel. (Potentially this bias line may be controlled to effectively disconnect a set of slave pixel driver circuits, should that be desired). Alternatively a bias voltage for one or more of the cascode transistors may be generated locally or potentially even be provided by the transistor itself (for example in a depletion mode junction FET the gate may simply be grounded).

Broadly speaking, the pixel driver architecture we have described comprises a voltage-programmed reference circuit configured to programme, using a current, a number of local sub-circuits. Various additional features and modifications have been described and the skilled person will recognize that features of the above described embodiments such as the use of cascode transistors, left and right slave circuits, and the like, may be combined in any permutation.

No doubt many other effective alternatives will occur to the skilled person. It will be understood that the invention is not limited to the described embodiments and encompasses modifications apparent to those skilled in the art lying within the spirit and scope of the claims appended hereto.

1. A pixel driver architecture for an active matrix organic light-emitting diode (OLED) display, the pixel driver architecture comprising:
a voltage-programmed master pixel programming circuit, said master pixel programming circuit being configured to produce a programmable current in response to programming voltage, wherein said master pixel programming circuit comprises a voltage programming line to receive a programming voltage defining a pixel luminance, a programmable current generator coupled to said voltage programming line to generate a programmed current responsive to said programming voltage, and a current output line to output said programmed current; and
a first plurality of current-programmed slave pixel driver circuits, each coupled to said master pixel programming circuit, and each configured to drive a respective OLED responsive to a said programming voltage received by said master pixel programming circuit, wherein a said slave pixel driver circuit comprises a current programming line coupled to said current output line of said master pixel programming circuit, an OLED current driver circuit having an OLED drive output to drive an OLED with a current programmed by said programmed current output from said master pixel programming circuit, and a pixel select line to select said current driver circuit for programming by said programmed current output.

2. A pixel driver architecture for an active matrix OLED as claimed in claim 1 wherein said master pixel programming circuit comprises an output transistor coupled to said current output line and a threshold voltage compensation circuit to compensate for a threshold voltage variation of said output transistor.

3. A pixel driver architecture for an active matrix OLED as claimed in claim 1 wherein said master pixel programming circuit further comprises an output transistor coupled to said current output line, and at least one control line to reduce a bias voltage on said output transistor when said programmed current is not output.

4. A pixel driver architecture for an active matrix OLED as claimed in claim 1 wherein said master pixel programming circuit comprises a current sense return line to output a signal responsive to a value of said programmed current, output on said current output line, for measuring said programmed current.

5. A pixel driver architecture for an active matrix OLED as claimed in claim 1 wherein said master pixel programming circuit comprises an output transistor coupled to said current output line, and wherein said output transistor is an n-channel transistor.

6. A pixel driver architecture for an active matrix OLED as claimed in claim 1 wherein a said slave pixel driver circuit comprises an OLED driver transistor coupled to said OLED drive output, and wherein said OLED driver transistor is an n-channel transistor.

7. A pixel driver architecture for an active matrix OLED as claimed in claim 1 further comprising a cascode transistor connected in series between said current output line of said master pixel programming circuit and said current programming line of each slave pixel driver circuit.

8. A pixel driver architecture for an active matrix OLED as claimed in claim 1 further comprising a controller configured to, for each said slave pixel driver circuit in turn: control said master pixel programming circuit to generate a said programmed current, select the respective slave pixel driver circuit, and allow said OLED drive output to settle prior to de-selecting the respective pixel slave driver circuit.

9. A pixel driver architecture for an active matrix OLED as claimed in claim 1, further comprising a second plurality of said current-programmed slave pixel driver circuits each coupled to said master pixel programming circuit and having a respective OLED drive output, wherein pixel driver circuitry of said first and second plurality of pixel driver circuits is paired such that each slave pixel driver circuit of said first plurality of pixel driver circuits has a corresponding slave pixel driver circuit in said second plurality of pixel driver circuits, wherein said paired pixel driver circuits share a common OLED drive line connected to a shared OLED, and wherein said pixel driver architecture further comprises at least one drive control line for each said pair of pixel driver circuits to select one or other of said paired pixel driver circuits to drive said shared OLED.

10. A pixel driver architecture for an active matrix OLED as claimed in claim 1 comprising a plurality of said master pixel programming circuits each coupled to a respective plurality of said slave pixel driver circuits.

11. A pixel driver architecture for an active matrix OLED as claimed in claim 10 wherein a product of total number of said voltage programming lines of said master pixel programming circuits and a total number of said pixel select lines is at least equal to a number of OLEDs driven by said pixel driver architecture.

12. A pixel driver architecture for an active matrix OLED as claimed in claim 10 wherein one or both of a said master pixel programming circuit and a said respective plurality of slave pixel driver circuits is fabricated on a chiplet.

13. An organic light emitting diode (OLED) display comprising a substrate bearing the pixel driver architecture of claim 12 and a plurality of OLED pixels, wherein each said OLED drive output of a said slave pixel driver circuit is connected to drive a respective OLED.

14. An OLED display as claimed in claim 13 wherein each said chiplet is mounted adjacent said respective OLEDs connected to said OLED drive outputs of said slave pixel driver circuits.

15. A method of driving an organic light-emitting diode (OLED) display, the method comprising:
providing a voltage-programmed master pixel programming circuit comprising a voltage-programmed current generator;
providing a plurality of current-programmed slave pixel driver circuits, each configured to drive an OLED with a current programmed by a current on a current programming line;
connecting the current programming lines of each of said slave pixel driver circuits to provide a shared current programming line;
programming said master pixel programming circuit with a voltage to generate a programmed current from said current generator;
programming a selected one of said slave pixel driver circuits by providing said programmed current from said current generator of said master pixel programming circuit to said shared current programming line;
driving an OLED connected to one of said selected slave pixel driver circuits with a current programmed by said voltage programming said master pixel programming circuit; and
repeating said programming of said master pixel programming circuit and of said selected one of said slave pixel driver circuits to program an OLED drive current for each of said slave pixel driver circuits.

16. An organic light-emitting diode (OLED) display comprising:
a voltage-programmed master pixel programming circuit comprising a voltage-programmed current generator;
a plurality of current-programmed slave pixel driver circuits each configured to drive an OLED with a current programmed by a current on a current programming line;
a shared current programming line connecting the current programming lines of each of said slave pixel driver circuits;
means for programming said master pixel programming circuit with a voltage to generate a programmed current from said current generator; and
means for programming a selected one of said slave pixel drive circuits by providing said a programmed current from said current generator of said master pixel programming circuit to said shared current programming line; and
means driving for an OLED connected to one of said selected slave pixel driver circuits with a current programmed by said voltage programming said master pixel programming circuit.

17. An OLED display as claimed in claim 16 further comprising a controller to repeat said programming of said master pixel programming circuits and a selected one of said slave pixel driver circuits to program an OLED drive current for each of said slave pixel driver circuits.
